(19) United States
(12) Patent Application Publication
(10) Pub. No.: US 2010/0000052 A1
(43) Pub. Date: Jan. 7, 2010

(54) SLIDE HINGE

(76) Inventor: Chia-Ko Chung, Shulin City (TW)

Correspondence Address: Hershkovitz & Associates, LLC, 2845 Duke Street, Alexandria, VA, 22314, US

(21) Appl. No.: 12/167,921

(22) Filed: Jul. 3, 2008

(51) Int. Cl. E05D 15/06

(52) U.S. Cl. 16/364

(57) ABSTRACT

A slide hinge has a stationary bracket, a slide, a pivot pin and a rotatable bracket. The stationary bracket is hollow and has a chamber and a rail slot. The slide is mounted slidably in the chamber of the stationary bracket. The pivot pin is mounted securely on the slide and extends perpendicularly from the stationary bracket. The rotatable bracket is mounted rotatably on the pivot pin. The slide hinge has merely four components so that fabricating the slide hinge is easy and fast. Therefore, the manufacturing cost of the slide hinge is low.

### BACKGROUND OF THE INVENTION

1. Field of the Invention

The present invention relates to a hinge, and more particularly to a slide hinge that is fabricated fast.

2. Description of Related Art

Portable electronic devices such as cellular phones and laptops generally have a base and a display pivotally and/or slidably connected to the base through a hinge.

A sliding-cover type electronic device employs a slide hinge to allow the display to slide on the base. However, conventional slide hinge for sliding-cover type electronic devices is structurally complicated and has too many components that lower the manufacturing rate of the slide hinge so that the manufacturing cost of the slide hinge is high.

To overcome the shortcomings, the present invention provides a slide hinge to mitigate or obviate the aforementioned problems.

### SUMMARY OF THE INVENTION

The main objective of the invention is to provide a slide hinge that is fabricated fast.

A slide hinge in accordance with the present invention has a stationary bracket, a slide, a pivot pin and a rotatable bracket. The stationary bracket is hollow and has a chamber and a rail slot. The slide is mounted slidably in the chamber of the stationary bracket. The pivot pin is mounted securely on the slide and extends perpendicularly from the stationary bracket. The rotatable bracket is mounted rotatably on the pivot pin.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an electronic device with a pair of slide hinges in accordance with the present invention;

FIG. 2 is a partially exploded perspective view of the electronic device with the hinges in FIG. 1;

FIG. 3 is an operational perspective view of the electronic device with the cover sliding out of the base by the slide hinges in FIG. 1;

FIG. 4 is an operational perspective view of the electronic device with the cover pivoting upward on the base by the slide hinges in FIG. 1; and

FIG. 5 is an exploded perspective view of the slide hinge in FIG. 1.

### DETAILED DESCRIPTION OF THE PREFERRED EMBODIMENT

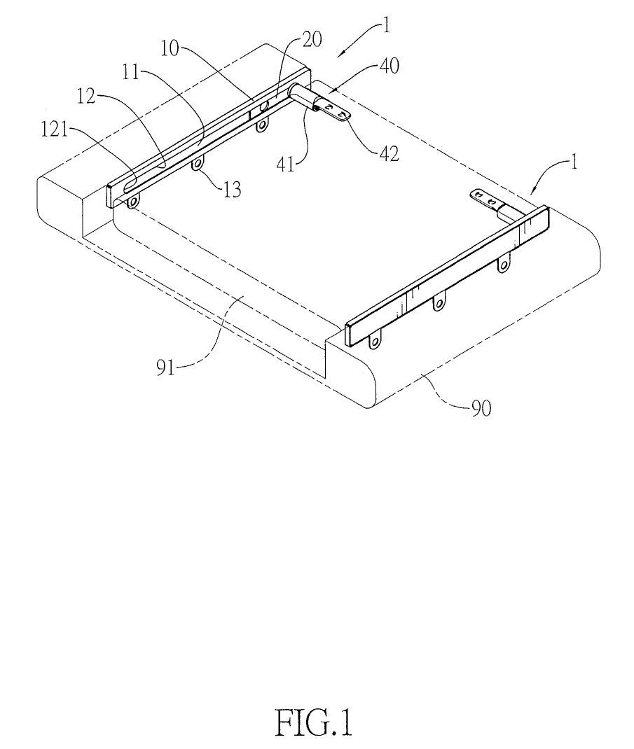

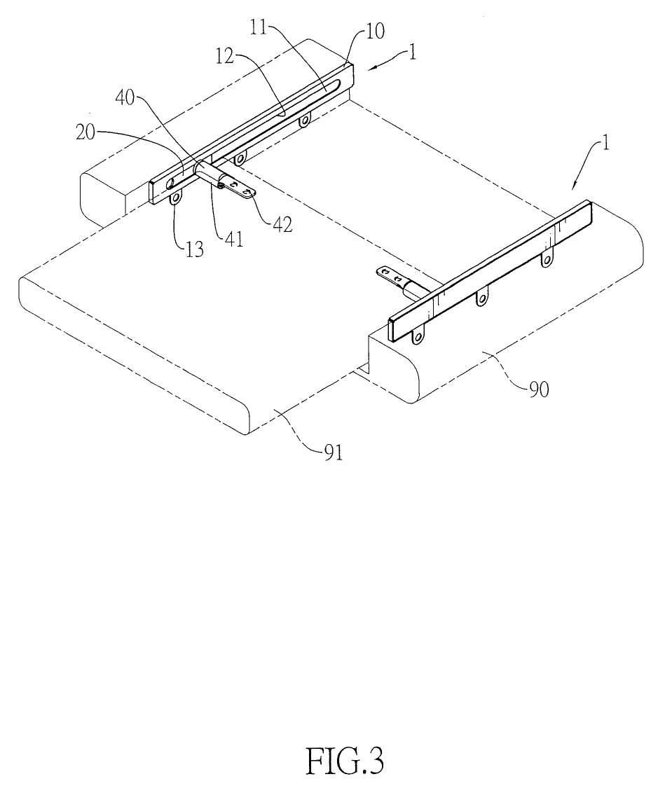

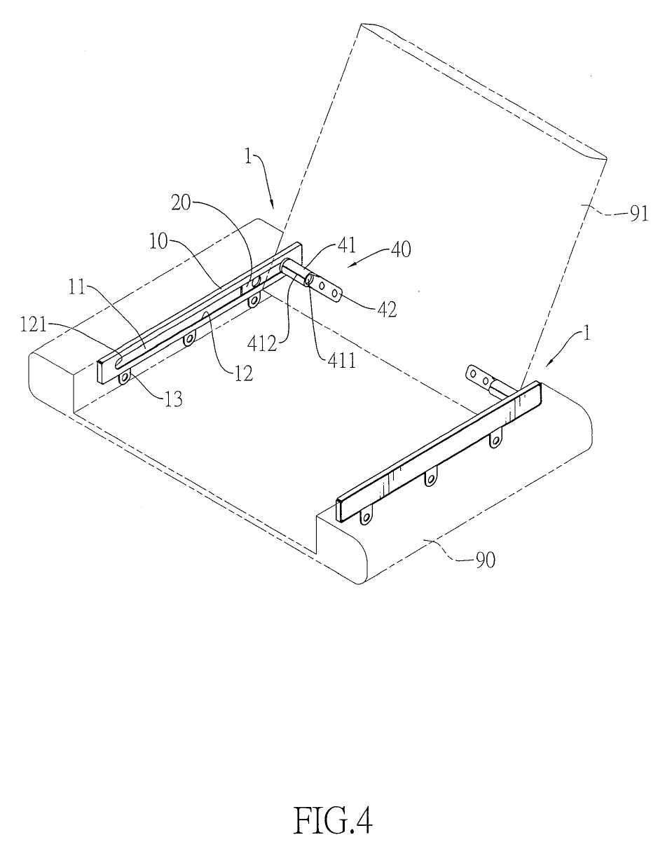

With reference to FIGS. 1, 3 and 4, a pair of slide hinges (1) in accordance with the present invention is mounted on an electronic device having a base (90) and a cover (91).

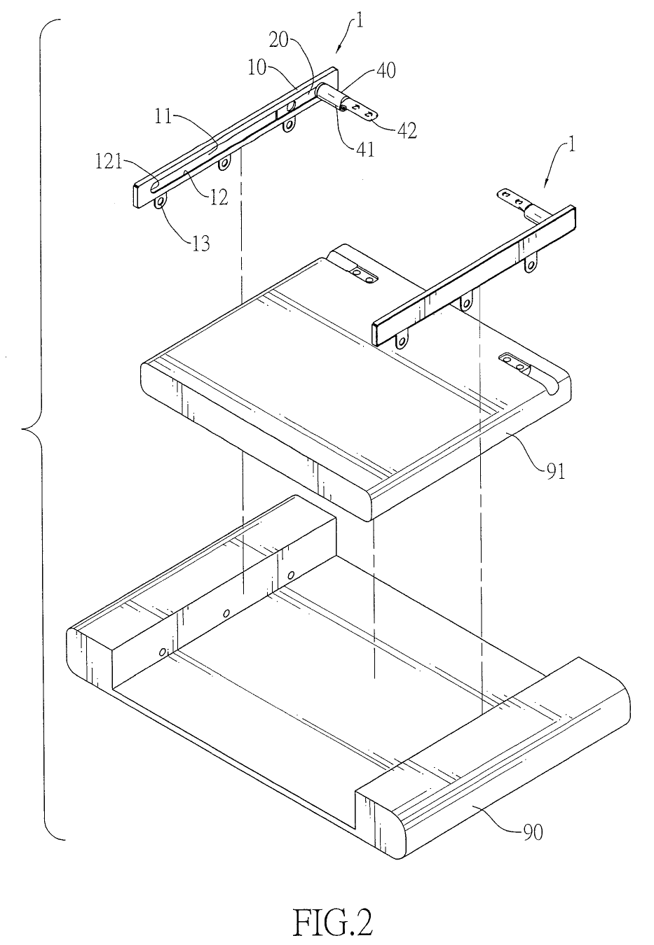

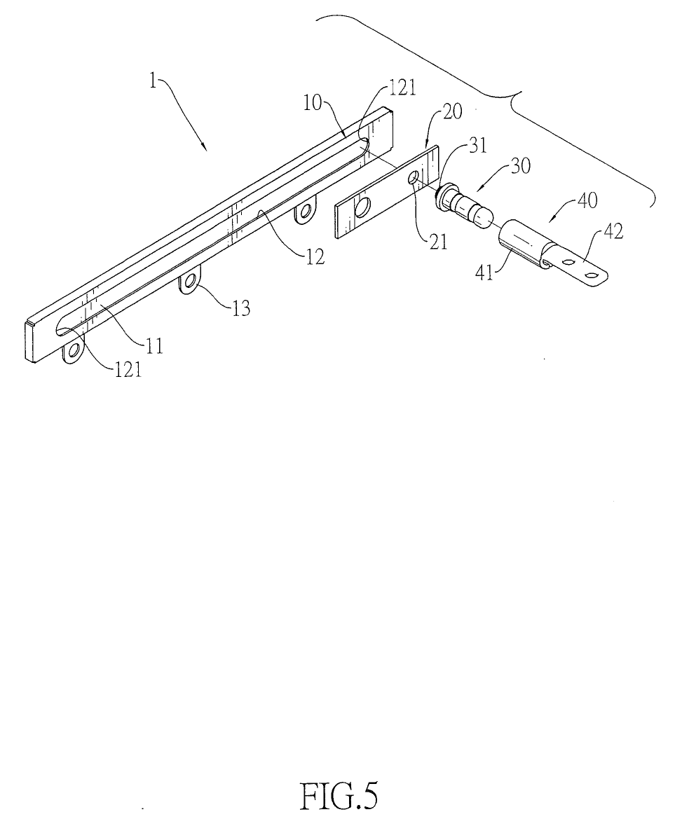

With further reference FIGS. 2 and 5, the base (90) has two opposite sides and may have an inputting interface such as a keyboard or buttons.

The cover (91) is connected pivotally to the opposite sides of the base (90), has two opposite side edges and may have a display.

The slide hinges (1) correspond respectively to and are securely mounted respectively on sides of the base (90) and correspond respectively to and are connected rotatably to the side edges of the cover (91) to allow the cover (91) to slide and pivot on the base (90). Each slide hinge (1) comprises a stationary bracket (10), a slide (20), a pivot pin (30) and a rotatable bracket (40).

The stationary bracket (10) is hollow and longitudinal, may be formed from a metal sheet by a stamping means, is mounted on a corresponding side of the base (90) and has two ends, an inside wall, a chamber (11) and a rail slot (12). The stationary bracket (10) may further have multiple mounting tabs (13). The chamber (11) is defined longitudinally in the stationary bracket (10). The rail slot (12) is defined through the inside wall of the stationary bracket (10), communicates with the chamber (11) and has two inner ends (121) and a width. The mounting tabs (13) are formed on the stationary bracket (10) in a row and each mounting tab (13) has a mounting hole. The mounting hole is defined through the mounting tab (13) to allow a bolt to extend through the mounting hole (13) into the base (10) to fasten the stationary bracket (10) on the base (90).

The slide (20) is mounted slidably in the chamber (11) of the stationary bracket (10) and has a width and a mounting bore (21). The width of the slide (20) is larger than that of the rail slot (12) to prevent the slide (20) from inadvertently falling out of the chamber (11). The mounting bore (21) is defined through the slide (20).

The pivot pin (30) is mounted securely on the slide (20), extends perpendicularly from the stationary bracket (10), selectively presses against one inner end (121) of the rail slot (12) and has a mounting end (31). The mounting end (31) is mounted through the mounting bore (21) of the slide (20) by a riveting means or soldering means.

The rotatable bracket (40) is mounted rotatably on the pivot pin (30) and has a barrel (41) and a leaf (42). The barrel (41) is hollow, is mounted rotatably around the pivot pin (30) and has a central hole (411) and a slit (412). The central hole (411) is defined longitudinally through the barrel (41) and is mounted around the pivot pin (30). The slit (411) is defined transversely through the barrel (41) so that the barrel (41) is flexible and has a C-shaped cross section to allow the diameter of the central hole (411) to be slightly changed. The leaf (42) is formed on and protruding longitudinally from the barrel (41) and is mounted securely on a corresponding side edge of the cover (91) to slidably and pivotally connect the cover (91) to the base (90).

Each slide hinge (1) has merely four components so that fabricating the slide hinge (1) is easy and fast. Therefore, the manufacturing cost of the slide hinge (1) is low.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A slide hinge comprising:
a stationary bracket being hollow and having
two ends;
an inside wall;
a chamber defined longitudinally in the stationary bracket; and
a rail slot defined through the inside wall of the stationary bracket, communicating with the chamber and having two inner ends;
a slide mounted slidably in the chamber of the stationary bracket;
a pivot pin mounted securely on the slide and extending perpendicularly from the stationary bracket; and
a rotatable bracket mounted rotatably on the pivot pin.

2. The slide hinge as claimed in claim 1, wherein the stationary bracket is formed from a metal sheet by a stamping means.

3. The slide hinge as claimed in claim 2, wherein:
the slide has a mounting bore defined through the slide; and
the pivot pin has a mounting end mounted through the mounting bore by a riveting means.

4. The slide hinge as claimed in claim 3, wherein the rotatably bracket has
a barrel being hollow, mounted rotatably around the pivot pin and having a central hole defined longitudinally through the barrel and mounted around the pivot pin; and
a leaf formed on and protruding longitudinally from the barrel.

5. The slide hinge as claimed in claim 4, wherein the barrel of the rotatably bracket further has a slit defined transversely through the barrel so that the barrel has a C-shaped cross section.

6. The slide hinge as claimed in claim 5, wherein the pivot pin selectively presses against one inner end of the rail slot.

7. The slide hinge as claimed in claim 6, wherein the stationary bracket further has multiple mounting tabs formed on the stationary bracket in a row and each mounting tab has a mounting hole defined through the mounting tab.

8. The slide hinge as claimed in claim 7, wherein a width of the slide is larger than that of the rail slot of the stationary bracket.
